(19) United States
(12) Patent Application Publication
(10) Pub. No.: US 2019/0297834 A1
(43) Pub. Date: Oct. 3, 2019

(54) PET SHELTER

(71) Applicant: Chuck Anthony Baker, Smyrna, TN (US)

(72) Inventor: Chuck Anthony Baker, Smyrna, TN (US)

(21) Appl. No.: 16/369,627

(22) Filed: Mar. 29, 2019

Related U.S. Application Data
(60) Provisional application No. 62/649,858, filed on Mar. 29, 2018.

(51) Int. Cl. A01K 1/00; A01K 1/03

(52) U.S. Cl. CPC A01K 1/0041; A01K 1/034; A01K 1/0058

(57) ABSTRACT

A pet shelter includes a floor, a roof, and a sidewall. The sidewall is made of a transparent material and joins the floor and the roof together. The sidewall includes a first portion joined to a second portion by a first bend, the second portion joined to a third portion by a second bend, the third portion joined to a fourth portion by a third bend, and the fourth portion joined to a fifth portion by a fourth bend defining an internal spiraled compartment An entrance to the internal spiraled compartment is defined in between the first portion and the fifth portion of the sidewall.

### CROSS-REFERENCE TO RELATED APPLICATION

This application claims the benefit of priority of U.S. provisional application No. 62/649,858, filed Mar. 29, 2018, the contents of which are herein incorporated by reference.

### BACKGROUND OF THE INVENTION

The present invention relates to a dog shelter and, more particularly, to an improved shelter for pet animals that provides a laterally panoramic view of surroundings from the inside while protecting the pet animal from the outside weather.

A doghouse, dog shed, or kennel is a small outdoor structure intended to provide a dog with a secure place for protection from various weather conditions. Doghouses may also be used for other pets, such as rabbits in enclosed yards. Current doghouses take the form of either open-air run-ins that protects the animals from precipitation only or closed traditional house-shaped dwellings that protect the animal from precipitation and wind but offer limited visibility via few, discrete windows. Many materials can be used for the construction of doghouses, such as wood, plastic, resin, and hardboard.

Pet animal shelters have long traded off occupant visibility for climate exposure-either providing full visibility with limited protection from the elements or limited visibility with a more comprehensive protection from the elements. These systems do not work well for outdoor working “guardian” pet animals, who require both a full view of their surroundings and protection from their climate. In addition, the existing protective shelters do not address the need for shelter to pet animals that have an aversion of dark, confined spaces and would rather risk exposure for environment awareness.

As can be seen, there is a need for an improved shelter for pet animals that provides a laterally panoramic view of surroundings from the inside while protecting the pet animal from the outside weather.

### SUMMARY OF THE INVENTION

In one aspect of the present invention, a pet shelter comprises: a floor; a roof; and a sidewall made of a transparent material joining the floor and the roof together, wherein the sidewall comprises a first portion joined to a second portion by a first bend, the second portion joined to a third portion by a second bend, the third portion joined to a fourth portion by a third bend, and the fourth portion joined to a fifth portion by a fourth bend defining an internal spiraled compartment, wherein an entrance to the internal spiraled compartment is defined in between the first portion and the fifth portion of the sidewall.

In another aspect of the present invention, a pet shelter comprises: a floor; a roof; and a sidewall comprising: a plurality of vertical columns connecting the floor to the roof; at least one spiral shaped rib connecting the plurality of vertical columns together; and a plurality of transparent panels coupled to the at least one spiral shaped rib, wherein the transparent panels define a first portion joined to a second portion by a first bend, the second portion joined to a third portion by a second bend, the third portion joined to a fourth portion by a third bend, and the fourth portion joined to a fifth portion by a fourth bend defining an internal spiraled compartment, wherein an entrance to the internal spiraled compartment is defined in between the first portion and the fifth portion of the transparent panels.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a cross-sectional view of the present invention, taken along line 2-2 in FIG. 1; and

FIG. 3 is a cross-sectional view of the present invention, taken along line 3-3 of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a pet shelter that provides both the openness of extended visibility and protection from both wind and precipitation. The present invention may achieve both extended visibility and protection to the inhabitant by a sparsely framed single-wall structure with a concave shell comprised of corrugated transparent polycarbonate panels.

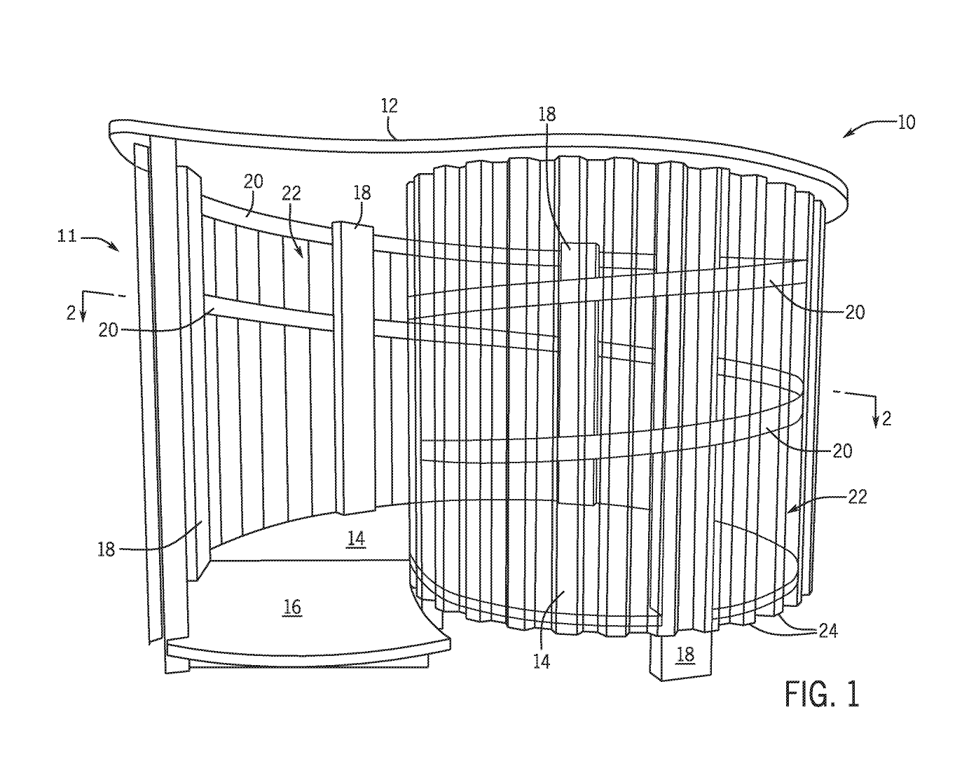

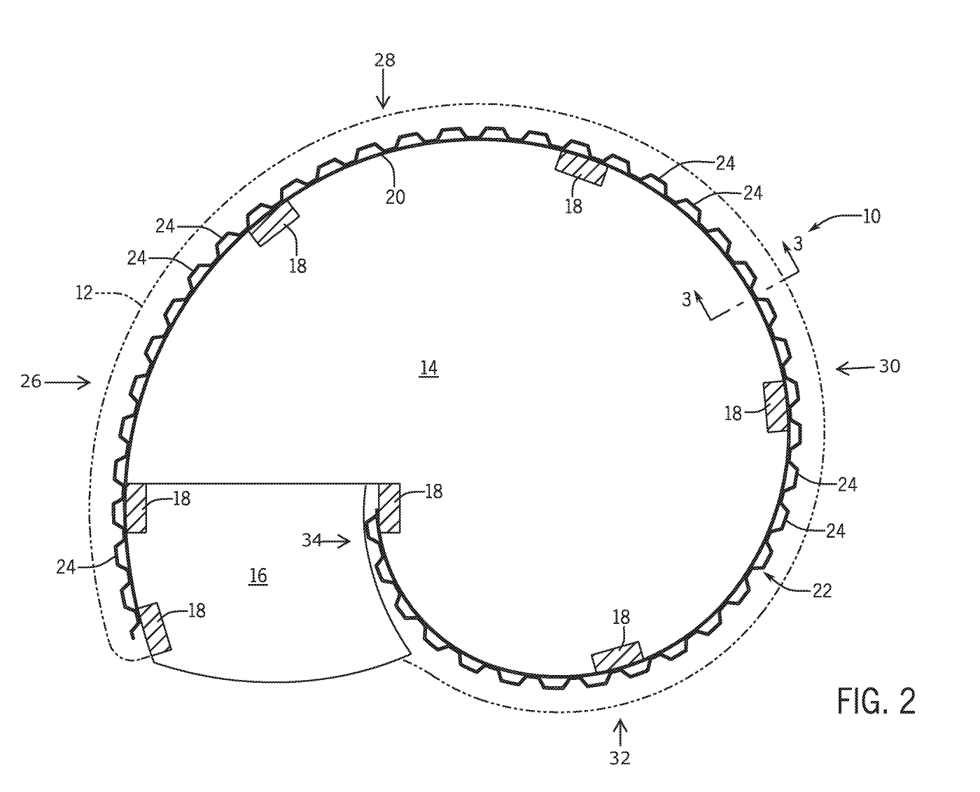

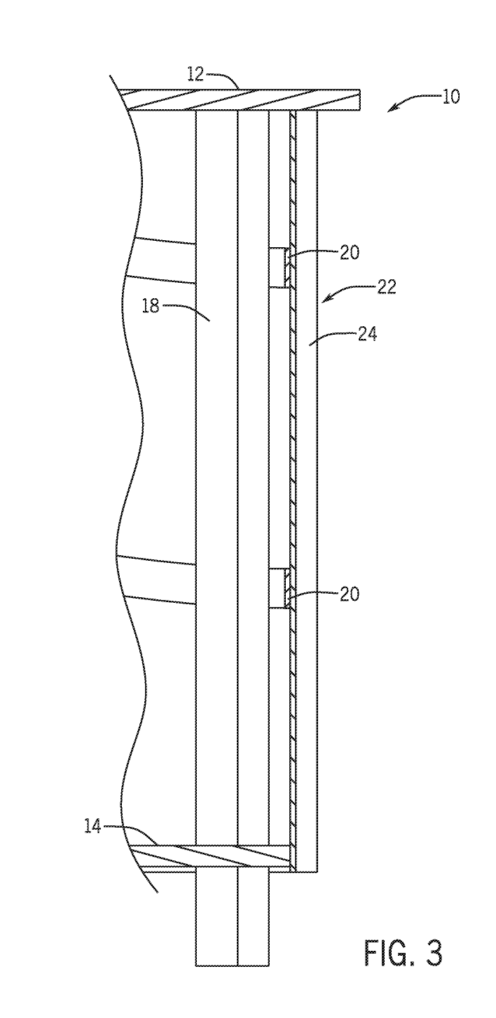

Referring to FIGS. 1 through 3, the present invention includes a pet shelter 10. The pet shelter 10 includes a floor 14, a roof 12 and a sidewall 11. The sidewall 11 is made of a transparent material and joins the floor 14 and the roof 12 together. The sidewall 11 includes a first portion 26 joined to a second portion 28 by a first bend, the second portion 28 joined to a third portion 30 by a second bend, the third portion 30 joined to a fourth portion 32 by a third bend, and the fourth portion 32 joined to a fifth portion 34 by a fourth bend defining an internal spiraled compartment An entrance to the internal spiraled compartment is defined in between the first portion 26 and the fifth portion 34 of the sidewall 11.

In certain embodiments, the sidewall 11 includes a continuous curve from the first portion to the fifth portion forming a rounded shape. However, in certain embodiments, the sidewall 11 includes a box shape. The floor 14 may be a substantially flat panel and the roof 12 may also be a substantially flat panel. The roof 12 may be angled away from the entrance, thereby allowing precipitation to flow off of the back of the pet shelter 10 and onto the ground. The pet shelter 10 may also include a ramp 16 coupled to the floor 14 at the entrance.

In certain embodiments, the sidewall 11 may include a plurality of vertical columns 18 connecting the floor 14 to the roof 12. A plurality of spiral shaped ribs 20 connect the plurality of vertical columns 18 together. A plurality of transparent panels 22 are couple to the spiral shaped ribs 20. Bottom ends of the plurality of vertical columns 18 may protrude beyond the floor 14 and define feet. The feet elevate the floor 14 above a surface when resting on the surface. The plurality of transparent panels 22 may be made out of polycarbonate and may include corrugations 24.

The ramp 16 and floor 14 assembly may include several roles. In addition to providing a place for the pet animal to enter and reside within the shelter 10, the assembly acts as a base 14, 16 for supporting the columns 18 at their intervals and the ribs 20 to provide radial support to the transparent panels 22. The roof 12 is supported by the columns 18 at an angle to allow precipitation run-off and may include an eave to prevent precipitation intrusion to the underlying ramp 16 and floor 14 assembly. The ribs 20 provide radial support to the panels 22 to maintain the panels' curvature and increase the panels' resistance to deformation from wind. The panels 22 are oriented with the corrugations 24 vertical to allow conformation to the wall shape and provide additional structural rigidity. The transparency of the panels 22 enables the panoramic view for the pet animal. A small gap between the panels 22 and the roof 12 along with the open corrugations at the base 14 provide ventilation to the shelter.

An exemplary method of making the present invention includes the following. Cut the floor 14, ramp 16, and roof 12 panel shapes from a solid weather-resistant material. Cut the columns 18 from a weather-resistant material and to a length to align with each other at the base 14, 16 and allow the roof panel 12 to slope for shedding precipitation by gravity once attached. Fasten the floor 14 to the ramp 16 at an angle to allow a lower access height to the elevated floor 14 and allow additional gravitational run-off of potential intruding precipitation. Fasten the columns 18 to the base 14, 16 and fasten the roof 12 to the columns 18. Fasten the ribs 20 to each of the columns 18. Cut the polycarbonate panels 22 to align with the base 14, 16 and match the top curved contour to the sloped roof 12 to minimize precipitation intrusion. Fasten the cut polycarbonate panels 22 to the columns 18, leaving a small offset between the roof 12 and the panels 22 to allow for air circulation. A shelter door may be added to the shelter entrance to further weatherproof the present invention.

In alternative embodiments, the floor 14 and roof 12 shapes can be of a differently-curved profile than illustrated and still maintain the visibility and strength of the single-walled shelter's configuration. An alternative transparent material (including glass or acrylic) could be used in place of the polycarbonate as the wall shell. A rigid enough shell material may eliminate the need for the structural ribs 20. The constructed gap between the panels 22 and the roof 12 could be eliminated to further weatherproof the present invention. The number of ribs 20 employed could be increased to further stiffen the structure. The column 18 heights could be manufactured to result in a flat roof 12 manufactured from a material capable of resisting degradation from standing precipitation.

It should be understood, of course, that the foregoing relates to exemplary embodiments of the invention and that modifications may be made without departing from the spirit and scope of the invention as set forth in the following claims.

What is claimed is:

1. A pet shelter comprising:
a floor;
a roof; and
a sidewall made of a transparent material and joining the floor and the roof together, wherein
the sidewall comprises a first portion joined to a second portion by a first bend, the second portion joined to a third portion by a second bend, the third portion joined to a fourth portion by a third bend, and the fourth portion joined to a fifth portion by a fourth bend defining an internal spiraled compartment, wherein an entrance to the internal spiraled compartment is defined in between the first portion and the fifth portion of the sidewall.

2. The pet shelter of claim 1, wherein the floor is a substantially flat panel and the roof is a substantially flat panel.

3. The pet shelter of claim 1, wherein the sidewall comprises a continuous curve from the first portion to the fifth portion.

4. The pet shelter of claim 1, wherein the sidewall comprises:
a plurality of vertical columns connecting the floor to the roof;
at least one spiral shaped rib connecting the plurality of vertical columns together; and
a plurality of transparent panels coupled to the at least one spiral shaped rib.

5. The pet shelter of claim 4, wherein the at least one spiral shaped rib comprises a plurality of spiral shaped ribs.

6. The pet shelter of claim 4, wherein the plurality of transparent panels are made of polycarbonate.

7. The pet shelter of claim 4, wherein bottom ends of the plurality of vertical columns protrude beyond the floor defining feet, wherein the feet elevate the floor above a surface when resting on the surface.

8. The pet shelter of claim 1, further comprising a ramp coupled to the floor at the entrance.

9. The pet shelter of claim 1, wherein an outer surface of the transparent panels comprises corrugations.

10. A pet shelter comprising:
a floor;
a roof; and
a sidewall comprising:
a plurality of vertical columns connecting the floor to the roof;
at least one spiral shaped rib connecting the plurality of vertical columns together; and
a plurality of transparent panels coupled to the at least one spiral shaped rib, wherein
the transparent panels define a first portion joined to a second portion by a first bend, the second portion joined to a third portion by a second bend, the third portion joined to a fourth portion by a third bend, and the fourth portion joined to a fifth portion by a fourth bend defining an internal spiraled compartment, wherein an entrance to the internal spiraled compartment is defined in between the first portion and the fifth portion of the transparent panels.
